(19) United States
(12) Patent Application Publication
(10) Pub. No.: US 2005/0151458 A1
(43) Pub. Date: Jul. 14, 2005

(54) Color cathode-ray tube

(76) Inventor: Bong Kyo Jeong, Daegukwangyuk-si (KR)

Correspondence Address: BIRCH STEWART KOLASCH & BIRCH, PO BOX 747, FALLS CHURCH, VA, 22040-0747, US

(21) Appl. No.: 10/944,811

(22) Filed: Sep. 21, 2004

(30) Foreign Application Priority Data
Jan. 13, 2004 (KR) 10-2004-0002322

(51) Int. Cl. H01J 29/10; H01J 31/00

(52) U.S. Cl. 313/479; 313/477 R

(57) ABSTRACT

The present invention relates to a color cathode-ray tube. According to the present invention, there is provided a color cathode-ray tube including a panel having an outer face substantially flat and an inner face having predetermined curvature, a funnel mounted in the rear of the panel, an electron gun inserted into a neck section of the funnel, for discharging an electron beam toward a screen, and a shadow mask disposed in such a manner as to be spaced apart from the inner surface of the panel by a predetermined distance, the shadow having a number of electron beam through-holes formed therein, wherein the outer coating film of the panel comprises a conductive polymer that prevents electromagnetic wave and static electricity, both of which are generated from the panel.

This Nonprovisional application claims priority under 35 U.S.C. § 119(a) on Patent Application No. 10-2004-0002322 filed in Korea on Jan. 13, 2004, the entire contents of which are hereby incorporated by reference.

### BACKGROUND OF THE INVENTION

1. Field of the Invention

The present invention relates to a color cathode-ray tube, and more particularly, to a color cathode-ray tube in order to shield electromagnetic wave and prevent electrification.

2. Description of the Background Art

The structure and problems of a conventional color cathode-ray tube will now be described with reference to the accompanying drawings.

FIG. 1 shows the structure of a general color cathode-ray tube and FIG. 2 shows the structure of a coating film of a panel of a cathode-ray tube according to the prior art.

Referring to FIG. 1, the color cathode-ray tube includes a panel 1 as a front glass, a funnel 2 as a rear glass, an electron gun 5 for discharging an electron beam 6 toward the panel, and a shadow mask 3 that serves as a color-selecting electrode, and a deflection yoke 4 that controls the electron beam 6 to be scanned in all directions with deflection. The panel 1 and the funnel 2 are connected to each other, so that a vacuum state is formed at the inner space defined between the panel 1 and the funnel 2.

The panel 1 is a portion corresponding to the screen of the cathode-ray tube, wherein picture information is converted into final time information. The panel 1 includes a face section 1a and lateral wall sections 1b extended vertically from both ends of the face section 1a. On the interior of the face section 1a surround by the lateral wall sections 1b, there is adhered a phosphor material layer 7 on which a phosphor material composed of a color component of each of red (R), green (G) and blue (B) is attached in a dot or strip shape. An anti-reflection and anti-electromagnetic wave film 1c is coated on the panel 1.

The shadow mask 3 is adapted to introduce a primary color electron beam discharged from the electron gun 5 to correctly reach the phosphor surface formed on the inside of the panel 1. A number of through-holes through which an electron beam can pass are formed in a metal plate. The shadow mask 3 is fixed to the lateral wall sections 1b of the panel by means of stud pins 9, which are welded to a mask frame 8, by means of a suspension spring (not shown). Furthermore, a magnetic shield (not shown) is fixed to the opposite side of the mask frame 8 to which the shadow mask 3 is fixed.

The electron gun 5 is a device that discharges the electron beam 6 in response to an electrical signal that indicates picture information. The electron gun 5 is inserted into and mounted in the funnel 2. The electron gun 5 is constructed of three elements since it is necessary to independently stimulate primary color phosphor material pixels.

The deflection yoke 4 serves to scan the electron beam 6 discharged from the electron gun 5 in all directions so that the electrical signal transmitted in time series is produced in a two-dimensional picture. Therefore, the electron beam reaches the phosphor material layer 7 through the shadow mask 3, and then the phosphor material layer 7 emits light according to energy of the electron beam, thus reappearing a picture.

In order to make the panel 1 flat, the color cathode-ray tube constructed above has a high radius of curvature (high flatness) so that the exterior of the face section 1a of the panel 1 is close to the plane. Also, the inside of the face section 1a on which the phosphor material layer 7 is formed has a radius of curvature of the extent that the shape of the plane is not damaged when the screen is viewed from the outside. This has a radius of curvature that is relatively smaller than the outer curvature.

In the above, the exterior of the panel of the cathode-ray tube has a smooth surface. External light is specularly reflected from the exterior of the panel. This has problems that it makes the eyes of a viewer who sees the screen in the front tired and can make it impossible for a viewer to see the screen itself.

Moreover, as the cathode-ray tube is made flat, a thickness on the lateral side is greater than that on the center side and a difference in brightness between the lateral side and the center side becomes large accordingly. For this reason, there is a problem that a picture on the center side is darker than that on the lateral side.

For the purpose of solving these problems, in the color cathode-ray tube according to the prior art, a silica based solution is coated on the exterior of the panel in order to reduce reflected rays by diffusedly reflecting external light and to remove an electrostatic charge by coating a conductive film having surface resistance on the exterior of the panel.

In the above, the construction of the outer coating film coated on the panel 1 will be described in detail with reference to the accompanying FIG. 2. The outer coating film of the panel 1 includes a first coating film 10 on which a silica based solution containing conductive metal oxide such as ITO (Indium Tin Oxide), Ag or Pd is coated by means of a spin coating method in order to prevent electrification, a second coating film 11 in which a SiO₂ solution having an anti-reflection function is coated on the first coating film by means of the spin coating method, and a third coating film 12 on which a SiO₂ solution is coated through spray in order to prevent glare and a fingerprint.

As described above, however, since the outer coating film of the conventional panel consists of three layers, its production yield is decreased in a coating process of the panel and particularly, Ag and Pd of ITO (Indium Tin Oxide) are very expensive, thereby causing a problem of the manufacturing cost being increased.

### SUMMARY OF THE INVENTION

Accordingly, an object of the present invention is to solve at least the problems and disadvantages of the background art.

An object of the present invention is to provide a color cathode-ray tube in which the outer coating film of a panel is formed of a pyrrole-based conductive polymer, thereby facilitating a coating process and reducing the manufacturing cost.

To achieve the above object, according to the present invention, there is provided a color cathode-ray tube including a panel having an outer face substantially flat and an inner face having predetermined curvature, a funnel mounted in the rear of the panel, an electron gun inserted into a neck section of the funnel, for discharging an electron beam toward a screen, and a shadow mask disposed in such a manner as to be spaced apart from the inner surface of the panel by a predetermined distance, the shadow having a number of electron beam through-holes formed therein, wherein the outer coating film of the panel comprises a conductive polymer that prevents electromagnetic wave and static electricity, both of which are generated from the panel.

Unlike a conventional panel in which a coating film on the exterior of a panel consists of three layers and a material is expensive, the exterior of a panel of a color cathode-ray tube according to the present invention can be formed of a single layer including a pyrrole-based conductive polymer. It is thus possible to facilitate a manufacture process and reduce the manufacturing cost.

### BRIEF DESCRIPTION OF THE DRAWINGS

The invention will be described in detail with reference to the following drawings in which like numerals refer to like elements.

FIG. 1 shows the structure of a general color cathode-ray tube.

FIG. 2 shows the structure of a coating film of a panel according to a prior art.

FIG. 3 shows the structure of a coating film of a panel according to the present invention.

FIG. 4 is a graph showing the relationship between the binder content of a coating solution and the film strength according to the present invention.

FIG. 5 is a graph showing the relationship between the content of TiN and transmission according to the present invention.

FIG. 6 is a graph showing the relationship between transmission and a thickness of a coating film according to the present invention.

FIG. 7 is a graph showing the relationship between the polymer content of a coating solution and the sheet resistance according to the present invention.

FIG. 8 shows a structural formula and a molecular formula of a pyrrole-based conductive polymer applied to the present invention.

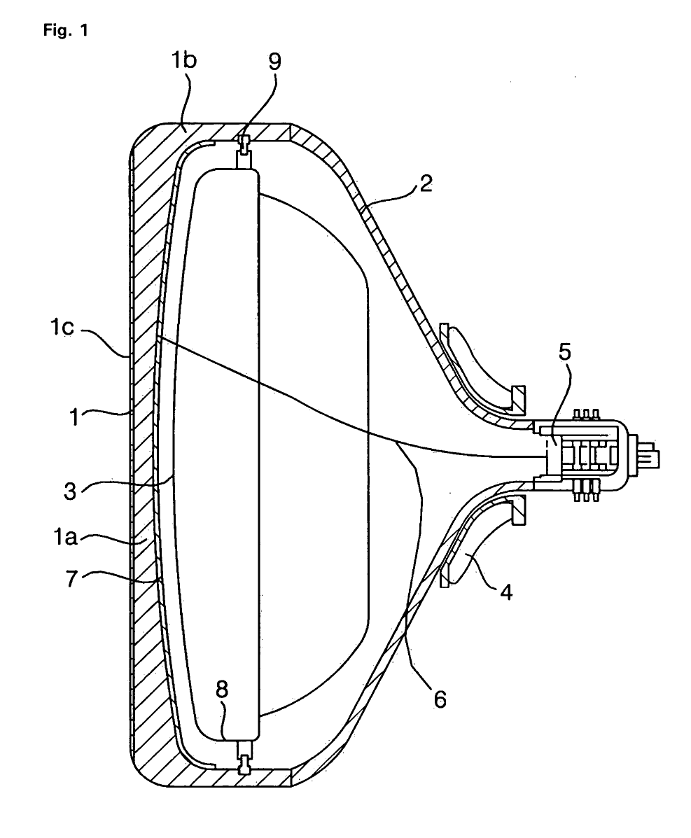

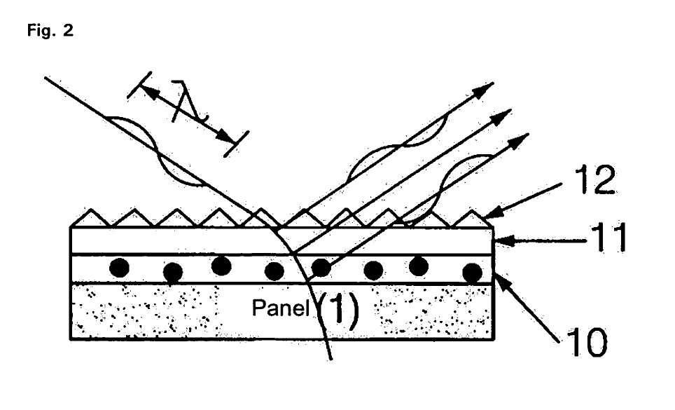

### DETAILED DESCRIPTION OF PREFERRED EMBODIMENTS

Preferred embodiments of the present invention will be described in a more detailed manner with reference to the drawings.

According to the present invention, there is provided a color cathode-ray tube including a panel having an outer face substantially flat and an inner face having predetermined curvature, a funnel mounted in the rear of the panel, an electron gun inserted into a neck section of the funnel, for discharging an electron beam toward a screen, and a shadow mask disposed in such a manner as to be spaced apart from the inner surface of the panel by a predetermined distance, the shadow having a number of electron beam through-holes formed therein, wherein the outer coating film of the panel comprises a conductive polymer that prevents electromagnetic wave and static electricity, both of which are generated from the panel.

Further, the conductive polymer is pyrrole-based material.

Further, the outer coating film of the panel consists of a single layer.

Further, the outer coating film of the panel has a range between 190 nm and 380 nm in thickness.

Further, the outer coating film of the panel includes titanium nitride (TiN) as a pigment that serves to color the panel and adjust transmission.

Further, the content of the titanium nitride (TiN) has a range between 0.3 wt % and 0.7 wt %.

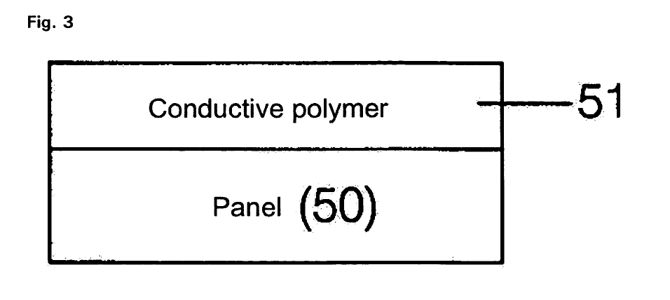

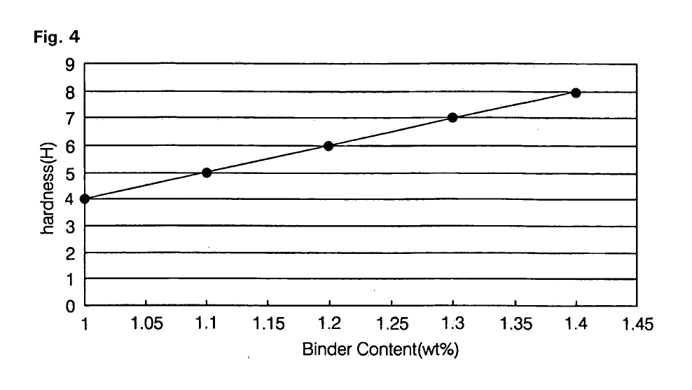

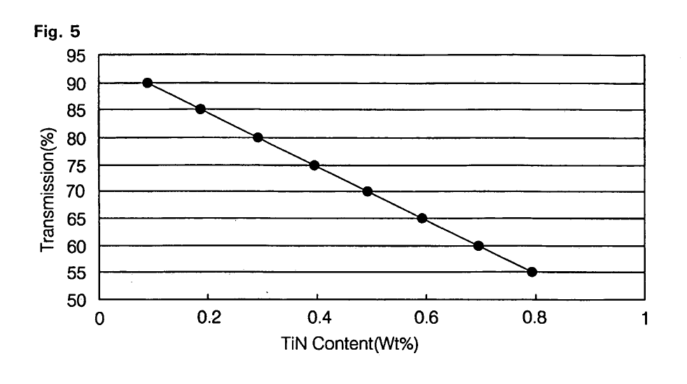

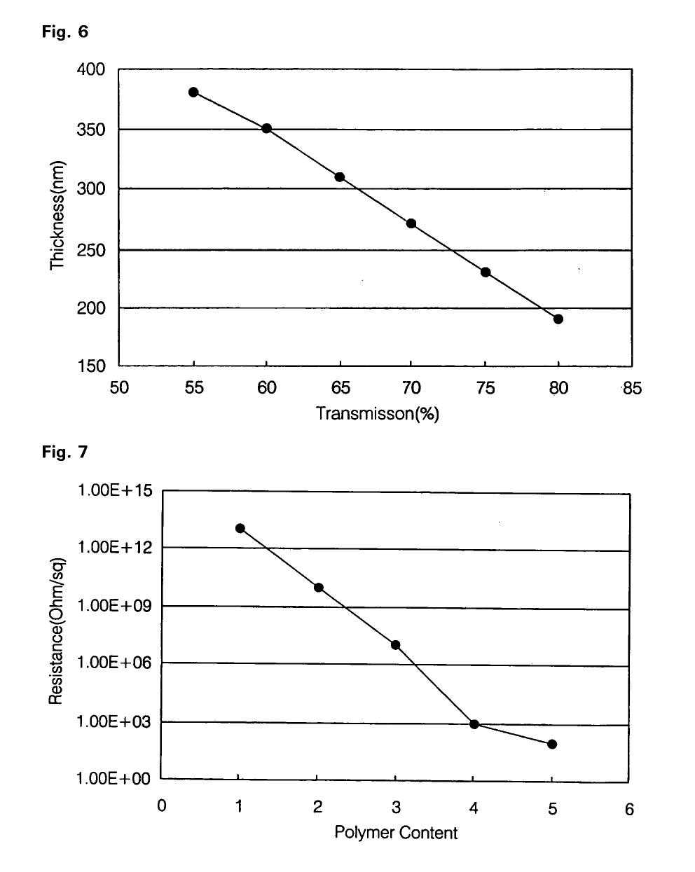

FIG. 3 shows the structure of a coating film of a panel according to the present invention. FIG. 4 is a graph showing the relationship between the binder content of a coating solution and the film strength according to the present invention. FIG. 5 is a graph showing the relationship between the content of TiN and transmission according to the present invention. FIG. 6 is a graph showing the relationship between transmission and a thickness of a coating film according to the present invention. FIG. 7 is a graph showing the relationship between the polymer content of a coating solution and the sheet resistance according to the present invention.

Referring to FIG. 3, the outer coating film of the panel of the color cathode-ray tube according to the present invention includes a single layer 51 having a pyrrole-based conductive polymer. The coating film also includes an alcohol that improves development of the coating film, a binder that enhances the film strength of the coating film, and a pigment that adjusts coloring and transmission.

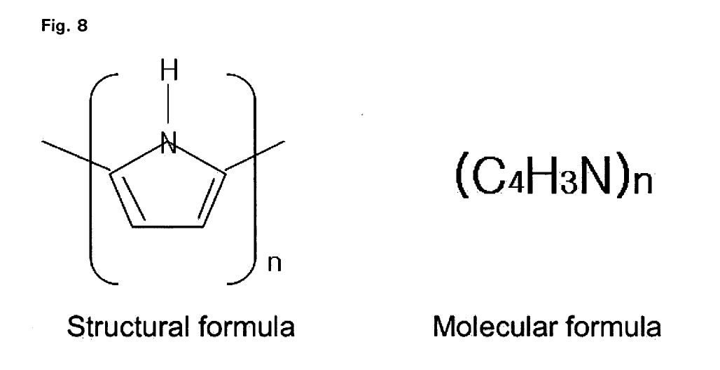

FIG. 8 shows a structural formula and a molecular formula of the pyrrole-based conductive polymer applied to the present invention. As an example of the pyrrole-based conductive polymer, in the present invention, the pyrrole-based conductive polymer having a molecular formula of (C₄H₃N)ₙ was used, as shown in FIG. 8. It is to be noted that any conductive polymer of the same kind as the above can be used. In this case, it is expected that the same effect as the above polymer would be obtained.

Generally, there exists an interrelationship between the film strength of the panel coating film and a coating solution in terms of a process. Specifically, the film strength has close relationship with a sintering temperature and a sintering time. More particularly, in the present invention, the binder has very close relationship with the film strength of the coating film.

FIG. 4 shows that the film strength of the coating film depending on the amount of the binder of the coating solution is indicated by H that designates hardness of a pencil. From FIG. 4, it can be seen that the film strength of the coating film is enhanced as the binder content of the coating solution rises. In the present invention, oxide nitride has been used as the binder. It is, however, to be understood that any material serving to combine titanium nitride (TiN) and a pyrrole-based conductive polymer can be used as the binder.

Meanwhile, the pigment has the greatest influence on transmission rate of the panel. In the present invention, titanium nitride (TiN) is used as the pigment. FIG. 5 shows the relationship between the content of titanium nitride (TiN) and transmission according to the present invention. From FIG. 5, it can be seen that the content of titanium nitride (TiN) must be 0.3 wt % to 0.7 wt % in order for transmission of the panel to have 60% to 80%.

The relationship between transmission of the panel and a thickness of the coating film will be described with reference to FIG. 6. If the thickness of the coating film is reduced, transmission of the panel is increased. On the contrary, if the thickness of the coating film is increased, transmission of the panel is reduced. In order for transmission of the panel to have a range between 55% and 80%, it is required that the thickness of the coating film have a range between 190 nm and 380 nm.

Moreover, in order to reduce electromagnetic wave that is generated from the deflection yoke of the color cathode-ray tube and then discharged toward the outside through the panel, it is required that sheet resistance of the panel plane be small. Therefore, from FIG. 7 that shows the relationship between the content of the pyrrole-based conductive polymer of the coating film and sheet resistance of the panel, it can be seen that the sheet resistance of the panel is reduced as the content of the conductive polymer of the coating film is increased.

Meanwhile, components of a coating solution that constitute the coating film of the panel according to the present invention will now be described with reference to Table 1 to Table 4 in comparison with components of a conventional coating solution.

Table 1 is a component table of a coating solution of a first coating film according to a prior art. Table 2 is a component table of a coating solution of a second coating film according to a prior art. Table 3 is a component table of a coating solution of a third coating film according to a prior art. Table 4 is a component table of a coating solution of a coating film according to the present invention.

TABLE 1

| Component Name | Content (wt %) |
|---|---|
| Alcohol | 80 |
| ITO/Ag/Pd/pigment | 1 |
| Water | 19 |

TABLE 2

| Component Name | Content (wt %) |
|---|---|
| Alcohol | 94.4 |
| Water | 4.5 |
| SiO₂ | 1.1 |

TABLE 3

| Component Name | Content (wt %) |
|---|---|
| Alcohol | 89.7 |
| Water | 10 |
| SiO₂ | 1.3 |

TABLE 4

| Component Name | Content (wt %) |
|---|---|
| Alcohol | 89.7 |
| Conductive Polymer | 5.5 to 6.5 |
| Pigment (TiN) | 1.3 |
| Other solvent(Binder, etc.) | 3.7 to 4 |

From Table 1 to Table 4, it can be seen that the coating solution of the present invention is composed of a simple composition as compared with the conventional coating solution. More particularly, the pyrrole-based conductive polymer is composed of an organic inorganic mixture. Therefore, the material itself serves as a low-reflection material. Further, titanium nitride (TiN) serves as coloring and an assistant conductive material. Accordingly, the conductive polymer and titanium nitride (TiN) can implement both diffused reflection and electrification functions.

According to the present invention as described above, an outer coating layer of a panel can be formed of a single layer including a pyrrole-based conductive polymer. It is thus possible to simplify a manufacturing process.

Furthermore, as a manufacturing process is simplified, the process yield is improved and reliability of a product is thus improved.

In addition, a pyrrole-based conductive polymer is very cheap as compared with an existing metal particle. Thus, a price competitiveness is improved depending on a reduction in the manufacturing cost.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A color cathode-ray tube including a panel having an outer face substantially flat and an inner face having predetermined curvature, a funnel mounted in the rear of the panel, an electron gun inserted into a neck section of the funnel, for discharging an electron beam toward a screen, and a shadow mask disposed in such a manner as to be spaced apart from the inner surface of the panel by a predetermined distance, the shadow having a number of electron beam through-holes formed therein,
wherein the outer coating film of the panel comprises a conductive polymer that prevents electromagnetic wave and static electricity, both of which are generated from the panel.

2. The color cathode-ray tube as claimed in claim 1, wherein the conductive polymer is pyrrole-based material.

3. The color cathode-ray tube as claimed in claim 1, wherein the outer coating film of the panel consists of a single layer.

4. The color cathode-ray tube as claimed in claim 1, wherein the outer coating film of the panel has a range between 190 nm and 380 nm in thickness.

5. The color cathode-ray tube as claimed in claim 1, wherein the outer coating film of the panel includes titanium nitride (TiN) as a pigment that serves to color the panel and adjust transmission.

6. The color cathode-ray tube as claimed in claim 5, wherein the content of the titanium nitride (TiN) has a range between 0.3 wt % and 0.7 wt %.
